(19) United States
(12) Patent Application Publication
(10) Pub. No.: US 2014/0114761 A1
(43) Pub. Date: Apr. 24, 2014

(54) PROVIDING PREVIOUSLY VIEWED CONTENT WITH SEARCH RESULTS

(71) Applicants: Wei-Hsin Lee, Saratoga, CA (US); Rahul Lahiri, Belmont, CA (US); Chiu Wah Kelvin So, Mountain View, CA (US)

(72) Inventors: Wei-Hsin Lee, Saratoga, CA (US); Rahul Lahiri, Belmont, CA (US); Chiu Wah Kelvin So, Mountain View, CA (US)

(21) Appl. No.: 13/659,559

(22) Filed: Oct. 24, 2012

(51) Int. Cl. G06Q 30/02

(52) U.S. Cl. 705/14.54

(57) ABSTRACT

Methods for providing sponsored content on a web page include receiving a plurality of keywords of a search query issued by a user. The methods further include receiving a first identifier and second identifier that identifies a product the user has previously viewed content for and the content provider of the content. A previously stored first sponsored content item associated with the product and content provider may be selected for participation in an auction. A second sponsored content item may be selected for participation in the auction, based on the plurality of keywords. If the first sponsored content item is selected based on the auction, the first sponsored content item is selected for inclusion on the web page.

### BACKGROUND

The present disclosure relates generally to systems and methods for providing content via the Internet.

### SUMMARY

In one implementation, in general, a computer-implemented method for providing sponsored content on a web page may include receiving, at a server, a plurality of keywords of a search query issued by a user. The method may also include receiving a first identifier that identifies a product about which the user has previously viewed content and a second identifier that identifies a content provider of the previously viewed content. The method may also include identifying, based on the first and second identifiers, a previously stored first sponsored content item associated with the product and sponsored by the content provider of the previously viewed content. The method may further include selecting the first sponsored content item for participation in an auction. The auction may be for selecting sponsored content items for inclusion on a web page including search results responsive to the search query. The selection of the first sponsored content item for participation in the auction may not be triggered by an association between the first sponsored content item and any of the plurality of keywords of the search query. The method may also include selecting a second sponsored content item for participation in the auction, wherein selection of the second sponsored content item is triggered by an association between the second sponsored content item and at least one of the plurality of keywords of the search query. The method may also include providing the first sponsored content item for inclusion on the web page if, based on the outcome of the auction, the first sponsored content item is selection for inclusion on the web page including the search results.

In another implementation, in general, a system including a processing circuit may be configured to receive a plurality of keywords of a search query issued by a user. The processing circuit may also be configured to receive a first identifier that identifies a product about which the user has previously viewed content and a second identifier that identifies a content provider of the previously viewed content. The processing circuit may also be configured to identify, based on the first and second identifiers, a previously stored first sponsored content item associated with the product and sponsored by the content provider of the previously viewed content. The processing circuit may also be configured to select the first sponsored content item for participation in an auction. The auction may be for selecting sponsored content items for inclusion on a web page including search results responsive to the search query. The selection of the first sponsored content item for participation in the auction may not be triggered by an association between the first sponsored content item and any of the plurality of keywords of the search query. The processing circuit may also be configured to select a second sponsored content item for participation in the auction, wherein selection of the second sponsored content item is triggered by an association between the second sponsored content item and at least one of the plurality of keywords of the search query. The processing circuit may also be configured to provide the first sponsored content item for inclusion on the web page if, based on the outcome of the auction, the first sponsored content item is selection for inclusion on the web page including the search results.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is an example of a block diagram of a computer system in accordance with a described implementation;

FIG. 2 is an illustration of a content item in accordance with a described implementation;

FIG. 3 is an illustration of a content item including additional information in accordance with a described implementation; and

FIG. 4 is an illustration of content for display with the additional previously viewed content provided to the user, in accordance with a described implementation; and

FIG. 5 is an example of a flow diagram of a method in accordance with a described implementation.

Like reference numbers and designations in the various drawings indicate like elements.

### DETAILED DESCRIPTION

Methods and systems are described herein of providing content (e.g., content items) to a user. In one example, the content may be provided along with search results on a resource, such as a web page. The content may appear along with personalized content in some implementations.

The present disclosure relates to a system and method related generally to using a user's behavior to provide content. When a user provides a search query to a search engine, content may be served. The content may be served based on the user's browser history, such as recently viewed items from a web page related to the search results. Along with the search results, 3^{rd} party web page visits are used to personalize and annotate content with the user's previously viewed content to make the search results relevant.

In an example, a user provides a search query on a search engine. For example, the user could search for “Store A.” The user may then receive a hyperlink and/or additional content related to “Store A.” The user may go to the web page associated with Store A and browse the web site.

The user may return to the search query at a subsequent time and search for “Store A.” The search results may appear with the hyperlink and/or additional content related to “Store A.” In addition, the user's previously viewed items may also appear alongside the content related to “Store A.”

In another implementation, when the user visits a particular web site, that web site includes a pixel tag. The pixel tag is then submitted to the search engine. The search engine may use the pixel tag to search a product catalog to determine which product the user has viewed. A product catalog may be built and associated with a user, e.g., using a user identifier, device identifier, cookie, etc. The identifier associated with the user is used to annotate the content with the user's previously viewed items.

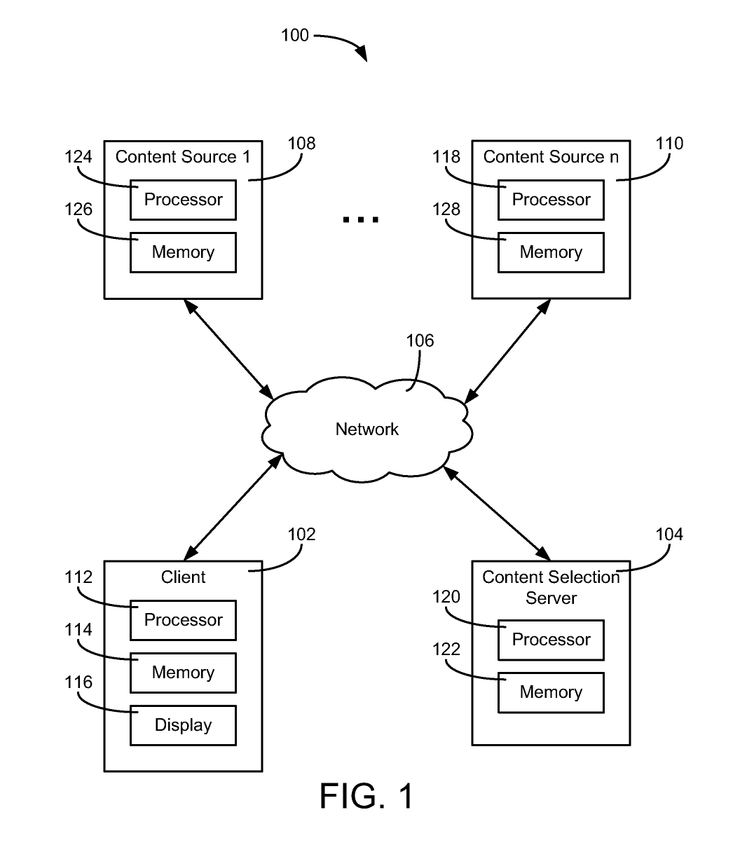

FIG. 1 is a block diagram of a computer system 100 in accordance with a described implementation. System 100 includes client 102, which may communicate with other computing devices via a network 106. For example, client 102 may communicate with one or more content sources ranging from a first content source 108 up to an nth content source 110. Content sources 108, 110 may provide webpages and/or media content (e.g., audio, video, and other forms of digital content) to clients client 102. System 100 may include an content selection server 104, which provides content to other computing devices over network 106.

Network 106 may be any form of computer network that relays information between client 102, content selection server 104, and content sources 108, 110. For example, network 106 may include the Internet and/or other types of data networks, such as a local area network (LAN), a wide area network (WAN), a cellular network, satellite network, or other types of data networks. Network 106 may include any number of computing devices (e.g., computer, servers, routers, network switches, etc.) that are configured to receive and/or transmit data within network 106. Network 106 may include any number of hardwired and/or wireless connections. For example, client 102 may communicate wirelessly (e.g., via WiFi, cellular, radio, etc.) with a transceiver that is hardwired (e.g., via a fiber optic cable, a CATS cable, etc.) to other computing devices in network 106.

Client 102 may be any number of different user electronic devices configured to communicate via network 106 (e.g., a laptop computer, a desktop computer, a tablet computer, a smartphone, a digital video recorder, a set-top box for a television, a video game console, etc.). Client 102 is shown to include a processor 112 and a memory 114, i.e., a processing circuit. Memory 114 stores machine instructions that, when executed by processor 112, cause processor 112 to perform one or more of the operations described herein. Processor 112 may include a microprocessor, application-specific integrated circuit (ASIC), field-programmable gate array (FPGA), etc., or combinations thereof. Memory 114 may include, but is not limited to, electronic, optical, magnetic, or any other storage or transmission device capable of providing processor 112 with program instructions. Memory 114 may include a floppy disk, CD-ROM, DVD, magnetic disk, memory chip, ASIC, FPGA, read-only memory (ROM), random-access memory (RAM), electrically-erasable ROM (EEPROM), erasable-programmable ROM (EPROM), flash memory, optical media, or any other suitable memory from which processor 112 can read instructions. The instructions may include code from any suitable computer-programming language such as, but not limited to, C, C++, C#, Java, JavaScript, Perl, Python and Visual Basic.

Client 102 may include one or more user interface devices. In general, a user interface device refers to any electronic device that conveys data to a user by generating sensory information (e.g., a visualization on a display, one or more sounds, etc.) and/or converts received sensory information from a user into electronic signals (e.g., a keyboard, a mouse, a pointing device, a touch screen display, a microphone, etc.). The one or more user interface devices may be internal to a housing of client 102 (e.g., a built-in display, microphone, etc.) or external to the housing of client 102 (e.g., a monitor connected to client 102, a speaker connected to client 102, etc.), according to various implementations. For example, client 102 may include an electronic display 116, which visually displays webpages using webpage data received from content sources 108, 110 and/or from content selection server 104.

Content sources 108, 110 are electronic devices connected to network 106 and provide media content to client 102. For example, content sources 108, 110 may be computer servers (e.g., FTP servers, file sharing servers, web servers, etc.) or other devices that include a processing circuit. Media content may include, but is not limited to, webpage data, a movie, a sound file, pictures, and other forms of data. Similarly, content selection server 104 may include a processing circuit including a processor 120 and a memory 122. In some implementations, content selection server 104 may include several computing devices (e.g., a data center, a network of servers, etc.). In such a case, the various devices of content selection server 104 may comprise a processing circuit (e.g., processor 120 represents the collective processors of the devices and memory 122 represents the collective memories of the devices).

Content selection server 104 may provide content to client 102 via network 106. For example, content source 108 may provide a webpage to client 102, in response to receiving a request for a webpage from client 102. In some implementations, content from content selection server 104 may be provided to client 102 indirectly. For example, content source 108 may receive content from content selection server 104 and use the content as part of the webpage data provided to client 102. In other implementations, content from content selection server 104 may be provided to client 102 directly. For example, content source 108 may provide webpage data to clients client 102 that includes a command to retrieve content from content selection server 104. On receipt of the webpage data, client 102 may retrieve content from content selection server 104 based on the command and display the content when the webpage is rendered on display 116.

The features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, or other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services (e.g., Netflix, Vudu, Hulu, etc.), a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate embodiments, the features may be implemented on a laptop computer or other personal computer, a smartphone, other mobile phone, handheld computer, a tablet PC, or other computing device.

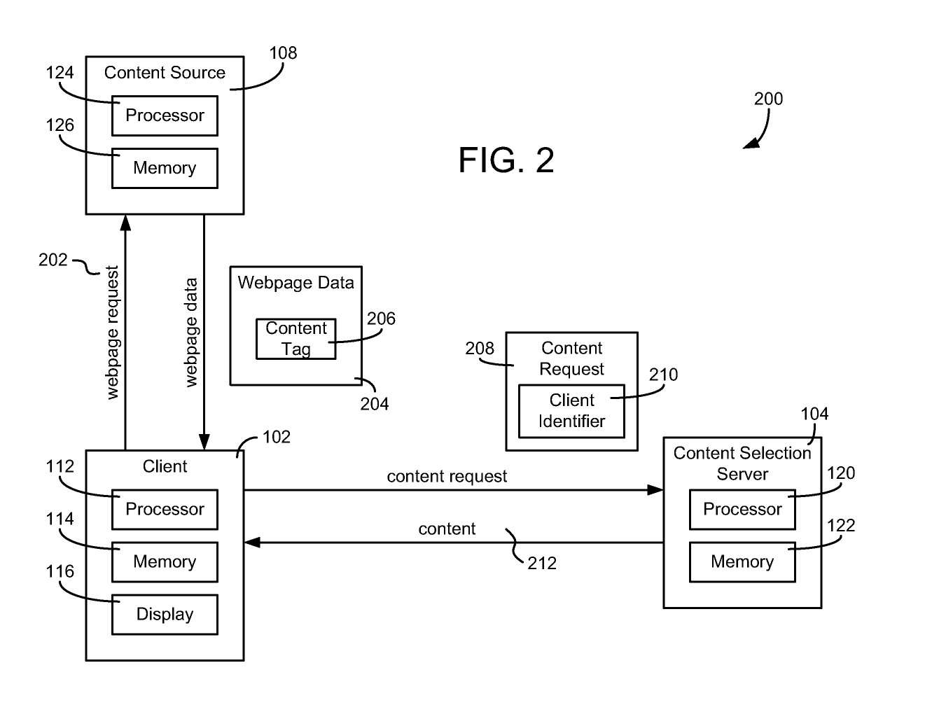

FIG. 2 is an example illustration of content 212 being selected by content selection server 104. As shown, client 102 may send a webpage request 202 to a content source via network 106, such as content source 108. For example, webpage request 202 may be a request that conforms to the hypertext transfer protocol (HTTP), such as the following:
GET /weather.html HTTP/1.1
Host: www.example.org

Such a request may include the name of the file to be retrieved, weather.html, as well as the network location of the file, www.example.org. In some cases, a network location may be an IP address or may be a domain name that resolves to an IP address of content source 108. In some implementations, a client identifier, such as a cookie associated with content source 108, may be included with webpage request 202 to identify client 102 to content source 108.

In response to receiving webpage request 202, content source 108 may return webpage data 204, such as the requested file, “weather.html.” Webpage data 204 may be configured to cause client 102 to display a webpage on electronic display 116 when opened by a web browser application. In some cases, webpage data 204 may include code that causes client 102 to request additional files to be used as part of the displayed webpage. For example, webpage data 204 may include an HTML image tag of the form:
<img src=“Monday_forecast.jpg”>

Such code may cause client 102 to request the image file “Monday_forecast.jpg,” from content source 108.

In some implementations, webpage data 204 may include content tag 206 configured to cause client 102 to retrieve an content from content selection server 104. In some cases, content tag 206 may be an HTML image tag that includes the network location of content selection server 104. In other cases, content tag 206 may be implemented using a client-side scripting language, such as JavaScript. For example, content tag 206 may be of the form:

<script type= ‘text/javascript’>
AdNetwork_RetrieveAd(“argument”)
</script>

Where AdNetwork_RetrieveAd is a script function that causes client 102 to send an content request 208 to content selection server 104. In some cases, the argument of the script function may include the network address of content selection server 104, the referring webpage, and/or additional information that may be used by content selection server 104 to select content to be included with the webpage.

Content request 208 may include a client identifier 210, used by content selection server 104 to identify client 102. In various implementations, client identifier 210 may be an HTTP cookie previously set by content selection server 104 on client 102, the IP address of client 102, a unique device serial for client 102, other forms of identification information, or combinations thereof. For example, content selection server 104 may set a cookie that includes a unique string of characters on client 102 when content is first requested by client 102 from content selection server 104. Such a cookie may be included in subsequent content requests sent to content selection server 104 by client 102.

In some implementations, client identifier 210 may be used by content selection server 104 to store history data for client 102, with the permission of the user of client 102. For example, content request 208 may include data relating to which webpage was requested by client 102, when the webpage was requested, and/or other history data. Whenever client 102 visits a webpage participating in the content network, i.e., a webpage that includes an content or other content selected by content selection server 104, content selection server 104 may receive and store history data for client 102. In this way, content selection server 104 is able to reconstruct the online history of client 102 regarding webpages in the content network. In some implementations, content selection server 104 may also receive history data for client 102 from entities outside of the content network. For example, a website that does not use content selected by content selection server 104 may nonetheless provide information about client 102 visiting the website to content selection server 104, with the user's permission.

In some cases, client identifier 210 may be sent to content selection server 104 when the user of client 102 performs a particular type of online action. For example, webpage data 204 may include a tag that causes client 102 to send client identifier 210 to content selection server 104 when the a displayed content is selected by the user of client 102. Client identifier 210 may also be used to record information after client 102 is redirected to another webpage. For example, client 102 may be redirected to a content provider's website if the user selects a displayed content. In such a case, client identifier 210 may also be used to record which actions were performed on the content provider's website. For example, client identifier 210 may also be sent to content selection server 104 as the user of client 102 navigates the content provider's website. In this way, data regarding whether the user searched for a product, added a product to a shopping cart, completed a purchase on the content provider's website, etc., may also be recorded by content selection server 104. In some implementations, content selection server 104 may use the data regarding users' online actions to calculate performance metrics for a webpage (e.g., a conversion rate, a click-through rate, etc.).

In response to receiving content request 208, content selection server 104 may select content 212 to be returned to client 102 and displayed on display 116. For example, content selection server 104 may select content 212 based on client identifier 210 and/or on a user identifier associated with client identifier 210. In one implementation, content selection server 104 may determine whether client identifier 210 corresponds to a similar user identifier as that of one or more other user identifiers. For example, content selection server 104 may determine whether a client identifier for client 102 is associated with characteristics that are similar to that of one or more other user identifiers specified by an content provider. Content selection server 104 may analyze history data for the one or more user identifiers specified by the content provider to identify characteristics of the user identifiers. The characteristics may be compared to those of the user identifier associated with client 102 to determine its similarity. In some implementations, content selection server 104 may determine a similarity score to represent how similar the characteristics of the user identifier is to that of the user identifiers specified by the content provider.

In some implementations, content selection server 104 may use characteristics of the one or more user identifiers specified by an content provider or other content source to train a behavioral model. For example, a large number of user identifiers associated with online purchases of insurance may have recently visited a webpage that compares rates among different insurance carriers. Such a characteristic may be used in a behavioral model by content selection server 104 to identify other user identifiers of users that may also be interested in purchasing insurance. In some implementations, the behavioral model may be constructed by representing a user identifier as a set of feature vectors. In general, a feature vector refers to an n-dimensional vector of characteristics of a user identifier, such as information about online actions associated with the user identifier. Characteristics of a user identifier may include webpages visited by the user identifier, contents selected by the user identifier, and/or contents selected by the user identifier that led to a conversion. In general, a conversion refers to the performance of a certain action. Typically, the action is the purchase of a good or service. For example, a selected content that led to a conversion may be an content that diverted a client device to a website at which a purchase was made. Other examples of conversions include creating a user profile on a website, subscribing to receive marketing offers (e.g., by providing a postal or email address, by providing a telephone number, etc.), or downloading software from a website.

In some implementations, characteristics of user identifiers may be normalized by utilizing a term-frequency inverse document frequency (TF-IDF) count. Webpages visited by a user identifier may be represented by their uniform resource location (URL) or similar addresses. A selected content may be an content embedded into a webpage, a game, a pop-up content, a banner content, or the like.

In some implementations, content selection server 104 may aggregate feature vectors to find a set of characteristics based on a statistical measurement of the aggregated characteristics. For example, the aggregated characteristics may be the number of times a webpage was visited by the set of user identifiers, the number of times an content or group of contents was selected, and/or the number of times an content or group of contents led to a conversion. In various implementations, a statistical measurement of the aggregated characteristics may be the average, median, centroid, or other statistical measure of the aggregated characteristics. In one implementation, the aggregated characteristics having the highest amount of activity may be selected (e.g., the top five most visited webpages, the top ten selected contents, etc.).

A received set of user identifiers may be subdivided by content selection server 104 into clusters to generate the behavioral model, in one implementation. In some cases, different groups of user identifiers may be associated with the same event and may be associated with widely different interests and motivations. For example, a roll of copper tubing may be purchased from an online hardware store both by plumbers and by hobbyists that homebrew beer. In such a case, the online histories for these two groups may widely differ. For example, the short-term histories of the plumbers may include a number of webpages devoted to making a certain type of plumbing repair. Likewise, the short-term histories of the hobbyists may include a number of webpages devoted to do-it-yourself projects to make a heat sink using copper tubing. Using clustering allows for the different groups of user identifiers to be treated separately in the behavioral model.

In some implementations, feature vectors may be subdivided into clusters by computing a weighted nearest-neighbor list for each user identifier in the set of user identifiers that content selection server 104 uses to train the behavioral model. For example, the feature vectors may be analyzed by content selection server 104 to determine which vectors are closest to one another. In one implementation, the nearest-neighbor list for the received set of user identifiers may be determined by applying a k-nearest-neighbor (KNN) algorithm, or similar algorithm, to the feature vectors. For example, webpages visited by plumbers may be used to form one cluster, while webpages visited by home brewing hobbyists may be used to form a second cluster, based on their nearest neighbors.

In some implementations, content selection server 104 may calculate a similarity score for the user identifier associated with client 102 based on how similar the characteristics of the user identifier are to those of one or more user identifiers specified by an auction participant (e.g., an content provider or other content provider). For example, an content provider may send a request to content selection server 104 to identify a user identifier similar to one or more user identifiers specified by the content provider. Content selection server 104 may determine whether the user identifier associated with client 102 is a similar user identifier and generate a similarity score for the user identifier. In some implementations, content selection server 104 may automatically generate a bid for the content provider or other content provider, in response to content selection server 104 receiving content request 208 from client 102. For example, if the user identifier of client 102 is determined to be similar to user identifiers specified by an content provider, content selection server 104 may generate a bid in the auction on behalf of the content provider. In one implementation, the bid may be determined by content selection server 104 based in part on the similarity score for the user identifier associated with client 102. Based on the results of the auction, content selection server 104 may select content 212 and return the content to client 102 or return an instruction to client 102 configured to cause client 102 to retrieve content from another source.

In some implementations, an image of the product related to the content may be served from the search engine. For example, a third party web page may install a pixel on their web page. When a user visits the web page, the pixel is provided to the search engine with a product identifier from the third party web page. The product identifier along with the pixel may be used to match up to the search results provided by the search engine. For example, when the user does a query for the third party web page at the search engine, the user's previously visited/viewed product identifier may be used to annotate the third party web page content on the search engine web page with an image of the product identifier provided by the search engine web page.

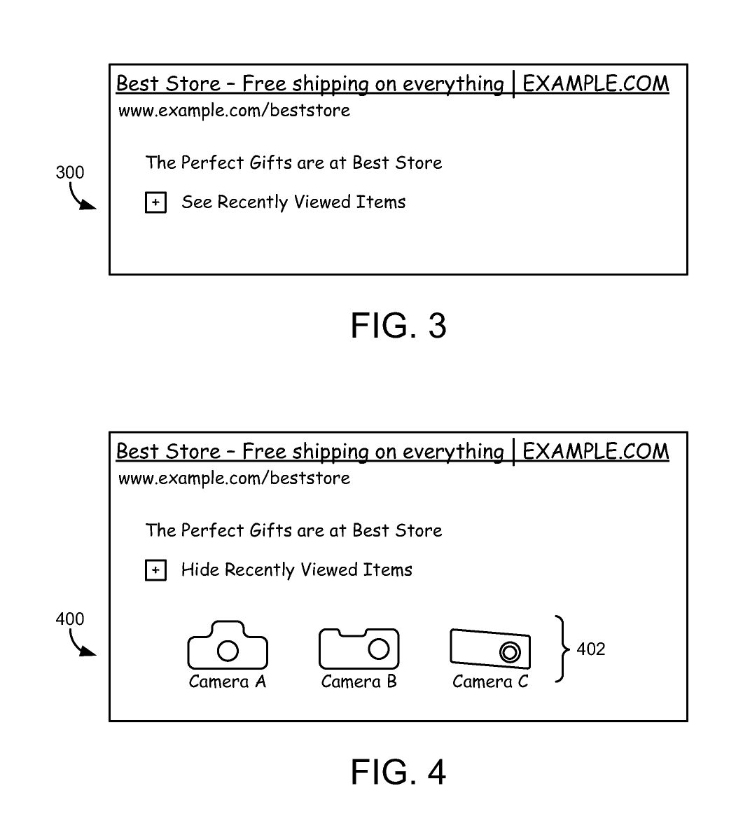

FIG. 3 is an illustration of a content item in accordance with a described implementation. Content item 300 may be displayed in addition to search results. For example, in response to a request for a search (e.g., news, Web, image, shopping, etc.), a user may be presented with content item 300. Content item 300 may be displayed near, adjacent to, etc. the search results on a web page. Content item 300 may include at least one of text, image, and video data.

The search engine and/or content server may select content that is determined to be appropriate for the user. The attributes of the search that the search engine or content server may use to provide content may include keywords, search terms, etc.

A placement for content item 300 may be determined by a content auction. The auction is held based on “clicks”, i.e., the content providers only has to pay the bid amount if a user actually clicks their ad. In some implementations, the content auction may also be held for content items that have been shown under a “recently viewed items” section. The content provider may adjust how much they are willing to bid for a placement that meets the criteria.

For example, each time a search query is performed using a keyword, search term, phrase, etc., a content auction is held. The content auction allows content providers to pay a bid amount if a user interacts with the content (e.g., clicks, impressions, engagement, etc.) Quality of the content may also affect the bid amount for the content provider. For example, the amount of interaction with the content by the user affects the quality. In another implementation, relevance of the content may determine quality. For example, the language and the text of the content with the keyword, phrase, etc. that is being bid on may be compared to determine relevancy. In yet another implementation, the landing page of the content is also useful in determining relevancy, such as the landing page helps the user find information that was provided in the search query.

The content auction may use the quality of the content and the maximum bid amount provided by the content provider to rank the content. The rank of the content may further depend on an actual cost per click, which takes into account another content provider's content rank and the quality.

Once the content auction has selected relevant content, then content item 300 may be displayed as provided in FIG. 3.

FIG. 4 is an illustration of content for display with the additional previously viewed content provided to the user, in accordance with a described implementation. Content item 400 may include previously viewed content 402. Content item 400 may be modified with previously viewed content 402 after the content auction.

For situations in which the systems discussed here collect personal information about users, or may make use of personal information, the users may be provided with an opportunity to control whether programs or features that may collect personal information (e.g., information about a user's social network, social actions or activities, a user's preferences, or a user's current location), or to control whether and/or how to receive content from the content server that may be more relevant to the user. In addition, certain data may be anonymized in one or more ways before it is stored or used, so that personally identifiable information is removed when generating parameters (e.g., demographic parameters). For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how much information is collected about him or her and used by a content server.

In some implementations, the device identifier is associated with a particular instance of a client application (e.g., running on client device 102). In some implementations, the device identifier is associated with a user (e.g., when the user logs in with a username and password). Some information that may be associated with the user may include events, such as one or more queries, one or more clicks, browser history data (e.g., the URLs visited, the number of URLs viewed, URL visit durations, etc.), etc. Events may also include advertising metrics, such as impressions, click through rate, etc. for each user. For example, the device identifier may include a time stamp associated with a particular event. Events may also include how many times a user is exposed to a particular ad, a campaign, etc.

Content source 108, 110 may select content to be provided with a webpage based on the device identifier for a user visiting the web page. For example, a user may opt in to receiving relevant contents from an content selection server. Rather than selecting an content to be provided on the web page based on the content of the web page itself or on other factors, content selection server 104 may take into account the device identifier provided as part of the content request. In one example, a user may visit a number of webpages devoted to reviews of golf clubs and later visit a webpage to check stock quotes. Based on the user's visits to the golf-related webpages, the user may be determined to be interested in receiving contents for golf clubs. When the user later visits the webpage to check stock quotes, an online retailer of golf equipment may seek to include an content on the webpage for that particular user, even though the financial webpage is unrelated to golf.

If content is selected based in part on a device identifier for a user that opts in to receiving more relevant content, a content provider may specify that certain content is to be provided to a set of device identifiers. For example, an content provider may identify a set of device identifiers associated with visiting the content provider's website and making a purchase. Such users may later wish to know if the content provider is running a sale. In some cases, an advertising network may identify users on behalf of the content provider that may be interested in receiving contents from the content provider. For example, content providers may specify a number of topic categories for their contents and the advertising network may match users' interests to the categories, to provide relevant contents to the users.

The content provider may store the user information, such as the browsing history, along with the content provider's URL. For example, the content provider may structure their own web site such that any URL in their website is mapped to an item, product, etc. on their website. In another example, the URL of an item, product, etc. on the content provider's website may contain a product identifier.

The content provider may implement a pixel tag. The pixel tag may be a clear GIF (graphics interchange format), a web beacon, etc. The pixel tag may be used in combination with an identifier, such as a cookie. The pixel tag may be placed on the content provider's website to observe the behavior of a user visiting the website. In some implementations, HTML for the pixel tag may point to the website to retrieve content (e.g., an image), and also pass information related to the retrieval of the content, the time the pixel tag was viewed and for how long, the type of browser, device, etc. that retrieved the image, previous set cookie values, etc.

The pixel tag may provide the identifier to the search engine via an HTTP request. The identifier may include a device identifier, product identifier, a content provider identifier, etc. The HTTP request may also include a cookie related to the search engine domain, which is associated with each user and/or session. The search engine, via a server, may receive the pixel tag and store the related identifier in a repository.

In some implementations, the search engine, via the server, may maintain a mapping for all content providers that implement the pixel tag. The map may relate the content provider's website (the product landing page URL) for the identifier.

In an example, content provider, such as example.com participates using the features described in FIG. 4. A user may have recently visited example.com. The pixel tag may have observed the user's behavior on various product pages related to cameras on example.com. When the user visits a search engine and performs a search for cameras, then example.com may win the content auction related to the search engine serving system. The search engine server may retrieve an identifier (e.g., a cookie, a content provider identifier, a product identifier, etc.). In some implementations, the product identifier may be used to retrieve the landing page URLs of the previously viewed cameras on example.com. The search engine server may provide the previously viewed content extension 402 and displayed to the user as part of the content related to cameras from example.com.

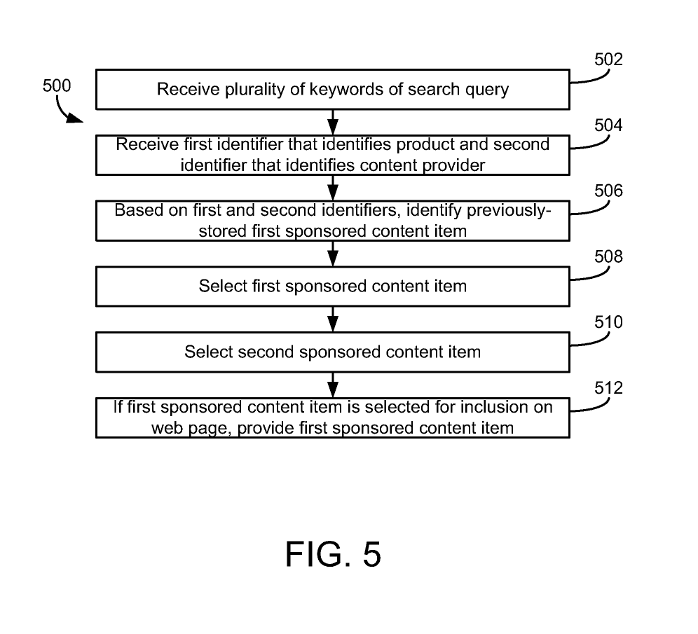

FIG. 5 is an example of a flow diagram of a method in accordance with a described implementation. Method 500 may be performed in any order. In some implementations, the steps of method 500 may be performed at the same time. Method 500 may be performed online or offline. Method 500 may be implemented in a variety of systems.

At block 502 of method 500, a plurality of keywords of a search query may be received. In some implementations, the search query may be received by a server. In some implementations, the search query may be received by a web browser. In some implementations, the search query is received from a user, visitor, etc. The search query may be text, audio, an image, etc. The plurality of keywords of the search query may be a phrase entered into an input field. One or more terms, phrases, etc. may be accepted from the search query. Additional information may be provided with the search query (or in the alternative), e.g., information related to the content of the page as well as a content item request. Multiple interpretations, associations, etc. may be generated for the search query. Each of these interpretations, associations, etc. may be explored, e.g., by a parsing algorithm. The most relevant interpretation may be selected and returned as part of the search results provided to the user. In some implementations, another step or steps may be performed for each term, phrase, etc.

At block 504, a first identifier and second identifier may be received. The first identifier may identify a product about which the user has previously viewed content. The second identifier may identify a content provider of the previously viewed content.

At block 506, a previously stored first sponsored content item associated with the product and sponsored by the content provider of the previously viewed content may be identified. The first sponsored content item and content provider may be identified based on the first identifier and second identifier. The first identifier and second identifier may be an indication of a user interaction with a product or content item. For example, the identifier may identify that the user may have selected a content item and was taken to the web page associated with that content item. The identifiers may include a device identifier, a product identifier, a content provider identifier, a cookie, or another indication of user interaction with the product or content item. The indications may include a pixel tag, web beacon, clear GIF, etc. The pixel tag may be used to build a product map, such as a product catalog that builds the products being viewed by a user. The pixel tag may provide the identifier to the search engine (e.g., the server associated with the search engine) via an HTTP request.

At block 508, the first sponsored content item may be selected for participation in an auction. The auction may be for selecting sponsored content items for inclusion on a web page including search results responsive to the search query of the user. The selection of the first sponsored content item for participation in the auction may not be triggered by an association between the first sponsored content item and any of the plurality of keywords of the search query.

At block 510, a second sponsored content item may be selected for participation in an auction. The selection of the second sponsored content item may be triggered by an association between the second sponsored content item and at least one of the plurality of keywords of the search query.

At block 512, if the first sponsored content item is selected for inclusion on the web page including the search results, then the first sponsored content item may be provided for inclusion on the web page. The first sponsored content item may be selected for inclusion on the web page based on the outcome of the auction. The web page including a set of search results selected based on the search query and the first sponsored content item may be provided. The content item may include at least one of text, image, interactive, rich media, and video data.

Implementations of the subject matter and the functional operations described in this specification can be implemented in other types of digital electronic circuitry, or in computer software, firmware, or hardware, including the structures disclosed in this specification and their structural equivalents, or in combinations of one or more of them.

Implementations of the subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, i.e., one or more modules of computer program instructions, encoded on one or more computer storage media for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be performed by a data processing apparatus on data stored on one or more computer-readable storage devices or received from other sources.

The term “data processing apparatus” or “computing device” encompasses all kinds of apparatus, devices, and machines for processing data, including by way of example a programmable processor, a computer, a system on a chip, or multiple ones, or combinations of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method for providing sponsored content on a web page, the method comprising:
receiving, at a server, a plurality of keywords of a search query issued by a user;
receiving a first identifier that identifies a product about which the user has previously viewed content and a second identifier that identifies a content provider of the previously-viewed content;
based on the first and second identifiers, identifying a previously-stored first sponsored content item associated with the product and sponsored by the content provider of the previously-viewed content;
selecting the first sponsored content item for participation in an auction for selecting sponsored content items for inclusion on a web page comprising search results responsive to the search query, wherein selection of the first sponsored content item for participation in the auction is not triggered by an association between the first sponsored content item and any of the plurality of keywords of the search query;
selecting a second sponsored content item for participation in the auction, wherein selection of the second sponsored content item for participation in the auction is triggered by an association between the second sponsored content item and at least one of the plurality of keywords of the search query; and
if, based on the outcome of the auction, the first sponsored content item is selected for inclusion on the web page comprising the search results, providing the first sponsored content item for inclusion on the web page.

2. The method of claim 1, wherein the search query is received by a web browser.

3. The method of claim 1, wherein the previously-viewed content comprises at least one of text, image, and video data.

4. The method of claim 1, wherein the first identifier comprises at least one of a device identifier, a unique identifier, and a cookie.

5. The method of claim 1, wherein the second identifier comprises at least one of a device identifier, a unique identifier, and a cookie.

6. The method of claim 1, wherein the first sponsored content item is an advertisement.

7. The method of claim 1, wherein the second sponsored content item is an advertisement.

8. The method of claim 1, wherein the association between the first sponsored content item and any of the plurality of keywords of the search query is specific to the user.

9. The method of claim 1, wherein the association between the second sponsored content item and at least one of the keywords of the search query is specific to the user.

10. The method of claim 2, wherein the search query is received in an address field of the web browser.

11. The method of claim 2, wherein the search query is received in a search field of the web browser.

12. A system comprising a processing circuit configured to:
receive a plurality of keywords of a search query issued by a user;
receive a first identifier that identifies a product about which the user has previously viewed content and a second identifier that identifies a content provider of the previously-viewed content;
based on the first and second identifiers, identify a previously-stored first sponsored content item associated with the product and sponsored by the content provider of the previously-viewed content;
select the first sponsored content item for participation in an auction for selecting sponsored content items for inclusion on a web page comprising search results responsive to the search query, wherein selection of the first sponsored content item for participation in the auction is not triggered by an association between the first sponsored content item and any of the plurality of keywords of the search query;
select a second sponsored content item for participation in the auction, wherein selection of the second sponsored content item for participation in the auction is triggered by an association between the second sponsored content item and at least one of the plurality of keywords of the search query; and
if, based on the outcome of the auction, the first sponsored content item is selected for inclusion on the web page comprising the search results, provide the first sponsored content item for inclusion on the web page.

13. The system of claim 12, wherein the search query is received by a web browser.

14. The system of claim 12, wherein the previously-viewed content comprises at least one of text, image, and video data.

15. The system of claim 12, wherein the first identifier comprises at least one of a device identifier, a unique identifier, and a cookie.

16. The system of claim 12, wherein the second identifier comprises at least one of a device identifier, a unique identifier, and a cookie.

17. The system of claim 12, wherein the first sponsored content item is an advertisement.

18. The system of claim 12, wherein the second sponsored content item is an advertisement.

19. The system of claim 12, wherein the association between the first sponsored content item and any of the plurality of keywords of the search query is specific to the user.

20. The system of claim 12, wherein the association between the second sponsored content item and at least one of the keywords of the search query is specific to the user.
